(19) United States
(12) Patent Application Publication
(10) Pub. No.: US 2024/0275273 A1
(43) Pub. Date: Aug. 15, 2024

(54) MULTI-MODE PFC CIRCUIT AND CONTROL METHOD THEREOF

(71) Applicant: Chengdu Monolithic Power Systems Co., Ltd., Chengdu (CN)

(72) Inventors: Guangzhuo Li, Hangzhou (CN); Jicheng Wang, Hangzhou (CN); Pengfei Liu, Hangzhou (CN); Hao Wang, Hangzhou (CN); Chuanhao Xu, Hangzhou (CN)

(21) Appl. No.: 18/645,519

(22) Filed: Apr. 25, 2024

(30) Foreign Application Priority Data
Apr. 25, 2023 (CN) 202310462223.9

(51) Int. Cl. H02M 1/42; H02M 3/155; H02M 7/155

(52) U.S. Cl. CPC H02M 1/4208; H02M 3/155; H02M 7/155

(57) ABSTRACT

A control circuit for controlling a PFC circuit is disclosed. The PFC circuit is controlled to operate in at least two working modes including CCM, BCM, and DCM in a single cycle of an input rectified voltage based on a load of the PFC circuit. The control circuit includes a control reference circuit and a switching control circuit. The control reference circuit provides a parameter control data based on a mode threshold and a half-sine wave signal. The switching control circuit provides a switching control signal to control a main power switch of the PFC circuit based on a current sense signal and the parameter control data. The current sense signal is indicative of a current flowing through an energy storage device of the PFC circuit.

### CROSS-REFERENCE TO RELATED APPLICATIONS

This application claims priority to and the benefit of Chinese Patent Application No. 202310462223.9, filed on Apr. 25, 2023, which is incorporated herein by reference in its entirety.

### TECHNICAL FIELD

The present invention relates generally to electronic circuits, and more particularly but not exclusively to PFC (Power Factor Correction) circuit and control method thereof.

### BACKGROUND OF THE INVENTION

PFC circuits are widely used in power conversion systems to correct an input current phase and to improve a power factor of the system, so as to reduce power dissipation.

Commonly, a rectified voltage is obtained by rectifying an AC voltage having a sine wave, and is provided to the PFC circuit as a power supply voltage. In order to implement PFC control, a waveform shape of the input current should follow a waveform shape of the rectified voltage, and the input current and the rectified voltage should be in phase. As shown in FIG. 1, an average current Iavg of an inductor current IL corresponds to the waveform of an input current Iac. The waveform of the input current Iac is controlled to be shown as a sine wave and to follow the waveform shape and the phase of the AC voltage for improving the power factor of the circuit.

In order to improve the efficiency, the PFC circuit has three working modes including CCM (Continuous Conduction Mode), BCM (Boundary Conduction Mode), and DCM (Discontinuous Conduction Mode). The working mode of the PFC circuit is determined by a load of the PFC circuit. Generally, the PFC circuit operates in CCM under heavy load, and operates in DCM under light load, and operates in BCM under medium load. The waveforms of the inductor current IL of the PFC circuit operating in CCM, BCM, and DCM are shown in FIG. 1.

### SUMMARY OF THE INVENTION

According to an embodiment of the present invention, a control circuit for controlling a PFC (Power Factor Correction) circuit is provided. The control circuit has a control reference circuit and a switching control circuit. The control reference circuit receives a mode threshold and a half-sine wave signal, and provides a parameter control data based on the mode threshold and the half-sine wave signal. The switching control circuit receives a current sense signal and the parameter control data, and provides a switching control signal to control a main power switch of the PFC circuit based on the current sense signal and the parameter control data. The current sense signal is indicative of a current flowing through an energy storage device of the PFC circuit. In a single cycle of an input rectified voltage, when the half-sine wave signal is larger than the mode threshold, the control circuit operates in CCM, when the half-sine wave signal is smaller than the mode threshold, the control circuit operates in BCM. The input rectified voltage is obtained by rectifying an AC voltage received by the PFC circuit.

According to another embodiment of the present invention, a PFC circuit is provided. The PFC circuit has a converting circuit, a rectifying circuit, and a control circuit. The rectifying circuit rectifies an AC voltage provided by an AC power supply to obtain an input rectified voltage and provides the input rectified voltage to an input terminal of the converting circuit. The control circuit provides a switching control signal to control a main power switch of the converting circuit. The control circuit has a control reference circuit and a switching control circuit. The control reference circuit receives a mode threshold and a half-sine wave signal, and provides a parameter control data based on the mode threshold and the half-sine wave signal. The switching control circuit receives a current sense signal and the parameter control data, and provides a switching control signal to control the main power switch of the PFC circuit based on the current sense signal and the parameter control data. The current sense signal is indicative of a current flowing through an energy storage device of the PFC circuit. In a single cycle of the input rectified voltage, when the half-sine wave signal is larger than the mode threshold, the control circuit operates in CCM, when the half-sine wave signal is smaller than the mode threshold, the control circuit operates in BCM.

According to yet another embodiment of the present invention, a control method for controlling a PFC circuit is provided. In a single cycle of a half-sine wave signal, when the half-sine wave signal is larger than a mode threshold, the PFC circuit operates in CCM. In a single cycle of the half-sine wave signal, when the half-sine wave signal is smaller than the mode threshold, the PFC circuit operates in BCM. A frequency of the half-sine wave signal is twice of a frequency of an AC voltage.

In one embodiment, the control method further includes: in a single cycle of the half-sine wave signal, when a peak value of the half-sine wave signal is smaller than a peak threshold, the PFC circuit operates in DCM. The peak threshold is smaller than the mode threshold.

### BRIEF DESCRIPTION OF THE DRAWINGS

The present invention can be further appreciated with reference to the following detailed description and the appended drawings.

FIG. 1 shows waveforms of an inductor current IL of a PFC circuit operating in different modes.

FIG. 2 schematically shows a PFC circuit 20 in accordance with an embodiment of the present invention.

FIG. 3 schematically shows a waveform of a current sense signal Ics of the PFC circuit 20 shown in FIG. 2 in accordance with an embodiment of the present invention.

FIG. 4 schematically shows a PFC circuit 40 in accordance with an embodiment of the present invention.

FIG. 5 schematically shows a switching control circuit 50 in accordance with an embodiment of the present invention.

FIG. 6 schematically shows a PFC circuit 60 in accordance with an embodiment of the present invention.

FIG. 7 schematically shows waveforms of the current sense signal Ics of the PFC circuit 60 shown in FIG. 6 operating under heavy load and light load in accordance with an embodiment of the present invention.

FIG. 8 schematically shows a switching control circuit 80 in accordance with an embodiment of the present invention.

FIG. 9 schematically shows a switching control circuit 90 in accordance with an embodiment of the present invention.

FIG. 10 schematically shows a PFC circuit 100 in accordance with an embodiment of the present invention.

FIG. 11 schematically shows the waveform of the current sense signal Ics of the PFC circuit 100 shown in FIG. 10 in accordance with an embodiment of the present invention.

FIG. 12 schematically shows a switching control circuit 120 in accordance with an embodiment of the present invention.

FIG. 13 schematically shows a PFC circuit 130 in accordance with an embodiment of the present invention.

FIG. 14 schematically shows a switching control circuit 140 in accordance with an embodiment of the present invention.

FIG. 15 schematically shows a flowchart of a control method 150 for a PFC circuit in accordance with an embodiment of the present invention.

FIG. 16 schematically shows a flowchart of a control method 160 for a PFC circuit in accordance with an embodiment of the present invention.

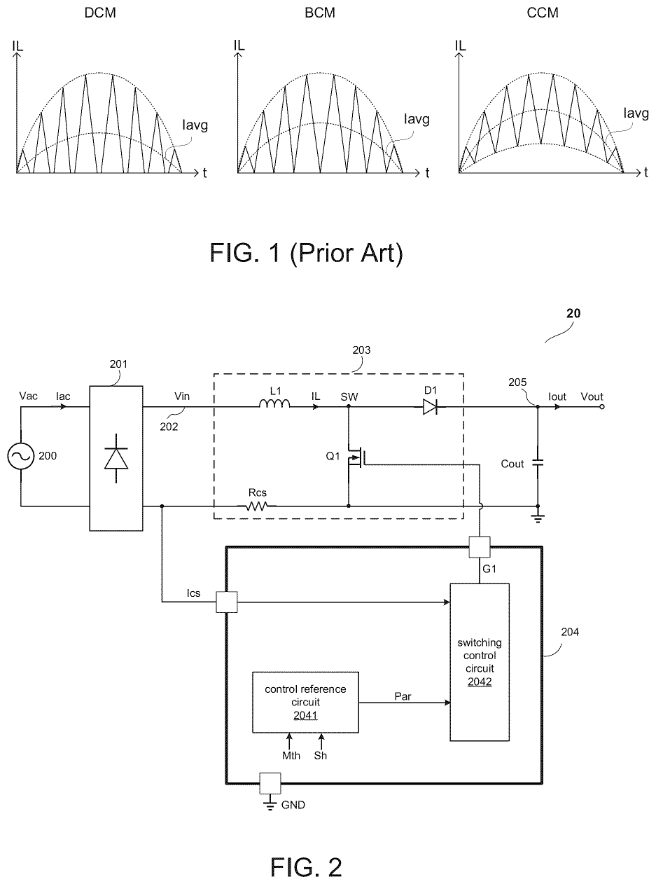

The use of the same reference label in different drawings indicates the same or like components.

### DETAILED DESCRIPTION

Various embodiments of the present invention will be described in detail below, and it should be noted that the embodiments described here are only for illustration. However, the present invention is not limited thereto. In the following description, numerous specific details, such as example circuits and example values for these circuit components, and methods are illustrated in order to provide a thorough understanding of the present invention. It will be apparent for persons having ordinary skill in the art that the present invention can be practiced without one or more specific details, or with other methods, components, materials. In other instances, well-known circuits, materials or methods are not shown or described in detail in order to avoid obscuring the present invention.

Throughout this description, the phrases “in one embodiment”, “in an embodiment”, “in some embodiments”, “in an example”, “in some examples”, “in one implementation”, and “in some implementations” as used to include both combinations and sub-combinations of various features described herein as well as variations and modifications thereof. These phrases used herein does not necessarily refer to the same embodiment, although it may. Additionally, persons having ordinary skill in the art should be appreciated that the drawings provided herein are for illustrative purposes and are not necessarily drawn to scale. The similar elements are provided with similar reference numerals. As used herein, the term “and/or” includes any combinations of one or more of the listed items.

FIG. 2 schematically shows a PFC circuit 20 in accordance with an embodiment of the present invention. The PFC circuit 20 includes a rectifying circuit 201, a converting circuit 203, and a power factor (PF) control circuit 204. The rectifying circuit 201 rectifies an AC voltage Vac from an AC power supply 200 to provide an input rectified voltage Vin having a half-sine wave, for powering the converting circuit 203. The converting circuit 203 is configured to convert the input rectified voltage Vin to an output voltage Vout for powering a load (not shown in FIG. 2). The PF control circuit 204 receives the output voltage Vout and a current sense signal Ics indicative of an inductor current IL, and provides a switching control signal G1 to control the converting circuit 203 based on the output voltage Vout and the current sense signal Ics. In one embodiment, the PF control circuit 204 is an integrated circuit. In some embodiments, the PF control circuit 204 may be integrated with one or all of a first switch Q1, a second switch D1, and an inductor L1 of the converting circuit 203 in a single chip.

In the embodiment shown in FIG. 2, the AC power supply 200 may include any AC power supplies, for example, power gird. The rectifying circuit 201 may include any suitable conventional rectifying circuits such as a full-bridge rectifying circuit, a half-bridge rectifying circuit, and the like.

In the embodiment shown in FIG. 2, the converting circuit 203 has a BOOST topology having the inductor L1, the first switch Q1, and the second switch D1. The inductor L1 is coupled between an input terminal 202 and a switching terminal SW. The first switch Q1 is coupled between the switching terminal SW and a ground reference GND. The second switch D1 is coupled between the switching terminal SW and an output terminal 205. The first switch Q1 and the second switch D2 are turned on and off alternately in response to the switching control signal G1. A working process of the converting circuit 203 is described below. When the first switch Q1 is turned on, the AC power supply 200, the rectifying circuit 201, the inductor L1, and the first switch Q1 form a loop. The inductor current IL representative of a current flowing through the inductor L1 increases. Meanwhile, an output capacitor Cout powers the load and maintains the output voltage Vout. When the first switch Q1 is turned off, the AC power supply 200, the rectifying circuit 201, the inductor L1, the second switch D1, the output capacitor Cout, and the load form another loop. The inductor current IL decreases, and meanwhile charges the output capacitor Cout to maintain the output voltage Vout. By utilizing the energy storage function of the inductor L1 and a proper control of a duty cycle of the first switch Q1, the output voltage Vout with a desired value could be provided.

In the embodiment shown FIG. 2, the converting circuit 203 further includes a current sense resistor Rcs coupled between the first switch Q1 and the rectifying circuit 201, for detecting the inductor current IL. Specifically, the inductor current IL flows through the current sense resistor Rcs to generate the current sense signal Ics. It should be appreciated that, the current sense signal Ics may be obtained by using other methods, and may be a suitable voltage signal or a current signal. There is a proportional relationship between the current sense signal les and the inductor current IL. When the current sense signal Ics indicative of the inductor current IL is utilized in circuit control, there should also be a corresponding proportional relationship for a current reference of the inductor current IL.

In the embodiment of FIG. 2, the BOOST topology is used as an example of the converting circuit 203. It should be appreciated that, the converting circuit 203 could have any other suitable topologies, such as a BUCK topology, a BUCK-BOOST topology, or a FLYBACK topology, etc. In the BOOST topology of the embodiment shown in FIG. 2, the first switch Q1 is referred as a main power switch, the second switch D1 is referred as a slave power switch, the inductor L1 is an energy storage device. It should be appreciated that, when the topology of the converting circuit changes, positions of the power switches and the energy storage devices should be changed accordingly. For example, in the FLYBACK topology, a primary side switch is referred as the main power switch, a secondary side switch is referred as the slave power switch, and a transformer is the energy storage device. Generally, when the main power switch is turned on and the slave power switch is turned off, the energy storage device of the converting circuit stores energy; and when the main power switch is turned off and the slave power switch is turned on, the energy storage device of the converting circuit releases energy.

In the embodiment shown in FIG. 2, the PF control circuit 204 includes a control reference circuit 2041 and a switching control circuit 2042. The control reference circuit 2041 receives a mode threshold Mth and a half-sine wave signal Sh, and provides a parameter control data Par based on the mode threshold Mth and the half-sine wave signal Sh. The switching control circuit 2042 receives the current sense signal Ics and the parameter control data Par, and provides the switching control signal G1 to control the first switch Q1 (i.e., the main power switch) of the PFC circuit 20 based on the current sense signal Ics and the parameter control data Par. The current sense signal Ics indicates a current flowing through the energy storage device (i.e., the inductor L1) of the PFC circuit 20. When the half-sine wave signal Sh is larger than the mode threshold Mth, the PFC circuit 20 and the PF control circuit 204 operate in CCM (Continuous Conduction Mode), otherwise, operate in BCM (Boundary Conduction Mode).

In one embodiment, the half-sine wave signal Sh may be an inductor average current value Iavg of the inductor current IL, the input rectified voltage Vin, or a voltage/current signal provided by rectifying the AC voltage Vac or input current Iac. In practical applications, the waveform of the inductor average current value Iavg is substantially consistent with the waveform of the current signal obtained by rectifying the input current Iac, and the waveform of the voltage signal obtained by rectifying the AC voltage Vac (i.e., the input rectified voltage Vin). In other words, all of them have the rectified sine wave. The inductor average current value Iavg indicates an average value of the inductor current IL. The waveform shape of the inductor average current value Iavg is similar to the waveform shape of the positive half-sine wave and could be measured by an oscilloscope and other devices. Meanwhile, the value of the inductor average current value Iavg indicates the load of the PFC circuit 20. When the load is heavier, a peak value Iavgp of the inductor average current value Iavg is larger. When the load is lighter, the peak value Iavgp of the inductor average current value Iavg is smaller. In following embodiments, the inductor average current value Iavg is illustrated as an example of the half-sine wave signal Sh, to describe the working mode control of the circuit. It should be appreciated that, in other embodiments, the working mode of the circuit may be determined by one or more of the input current Iac, the input rectified voltage Vin, and the AC voltage Vac. In other words, in the embodiments of the present invention, the working mode of the circuit is determined by the half-sine wave signal Sh. The frequency of the half-sine wave signal is twice of the frequency of the AC voltage Vac and input current Iac, and is equal to frequency of the input rectified voltage Vin and the inductor average current value Iavg. It should be appreciated that, the value and form of the mode threshold Mth should be adjusted along with the half-sine wave signal.

The parameter control data Par includes at least one parameter. In one embodiment, the parameter control data Par includes a current peak value Ipeak and a current valley value Ivalley.

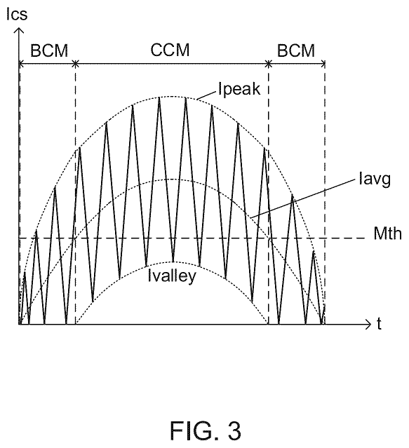

FIG. 3 schematically shows a waveform of the current sense signal Ics of the PFC circuit 20 in accordance with an embodiment of the present invention. Reference will now be made to FIG. 2 and FIG. 3 to describe the working principle of the PFC circuit 20.

It should be appreciated that, the AC voltage Vac is periodic no matter it is provided by mains supply or other power supplies, and the AC voltage Vac has a positive half-sine wave and a negative half-sine wave in a single cycle. After rectifying the AC voltage Vac, the negative half-sine wave is rectified into positive, and then the input rectified voltage Vin is obtained. Therefore, the period of the input rectified voltage Vin is half of the period of the AC voltage Vac, and the frequency of the input rectified voltage Vin is twice of the frequency of the AC voltage Vac. Due to the power factor correction function of the PFC circuit 20, the average value of the inductor current IL is controlled to follow the waveform shape of the input rectified voltage Vin, and the waveform shape of the input current Iac is controlled to follow the waveform shape of the AC voltage Vac accordingly. In the PFC circuit 20 shown in FIG. 2, the waveform of the input rectified voltage Vin has a shape of half-sine wave, and the waveform of the inductor average current value Iavg (indicating the average value of the inductor current IL) has a shape similar to the half-sine wave, as shown in FIG. 3. Under heavy load, a peak value Iavgp of the inductor average current value Iavg is greater than the mode threshold Mth. In some embodiments of the present invention, in a single cycle of the input rectified voltage Vin (i.e., in a single cycle of the inductor average current value Iavg): when the inductor average current value Iavg is larger than the mode threshold Mth, the PFC circuit 20 operates in CCM; when the inductor average current value Iavg is smaller than the mode threshold Mth, the PFC circuit 20 operates in BCM.

In CCM, the ripple of the inductor current IL is fixed. The current peak value Ipeak is set to Ipeak=Iavg+Iref1. The current valley value Ivalley is set to Ivalley=Iavg−Iref1. The Iref represents the current reference, which could be set by persons skilled in the art according to specifications and requirements of practical applications. In one embodiment, the value of the current reference Iref is equal to the value of the mode threshold Mth. It should be appreciated that, in the embodiments of the FIGS. 2-3, the current peak value Ipeak and the current valley value Ivalley correspond to the current sense signal Ics indicative of the inductor current IL. The switching control circuit 2042 receives the current sense signal Ics and the parameter control data Par including the current peak value Ipeak and the current valley value Ivalley, and provides the switching control signal G1 to control the first switch Q1. The working principle is described in below. When the first switch Q1 is turned on, the power supply is coupled to the inductor L1 to charge the inductor L1, the inductor current IL increases, the current sense signal Ics increases accordingly. When the current sense signal Ics increases to the current peak value Ipeak, the first switch Q1 is turned off by the switching control signal G1 and the second switch D1 is turned on. The inductor L1 powers the output capacitor Cout and the load, the inductor current IL and the current sense signal Ics decrease. When the current sense signal Ics decreases to the current valley value Ivalley, the first switch Q1 is turned on by the switching control signal G1 and the second switch D1 is turned off. The inductor current IL increases, and the operation repeats. In the embodiment of FIG. 2, the second switch D1 is implemented by a diode. The second switch D1 and the first switch Q1 are turned on and off alternately. It should be appreciated that, the second switch D1 could be implemented by a suitable controllable switch (e.g., MOSFET) instead of the diode, and the switching control signal G1 could also be used to control the controllable switch.

In BCM, the current valley value Ivalley is zero. The current peak value Ipeak is set to Ipeak=2×Iavg. The working principle of the PFC circuit 20 operating in BCM is similar to the working principle of the PFC circuit 20 operating in CCM. The main difference is that the current peak value Ipeak and the current valley value Ivalley are different in BCM and CCM.

In one embodiment, when the load of the PFC circuit 20 is light, the peak value Iavgp of the inductor average current value Iavg is smaller than the mode threshold Mth. In this case, the PFC circuit 20 operates in BCM in the whole cycle of the inductor current IL.

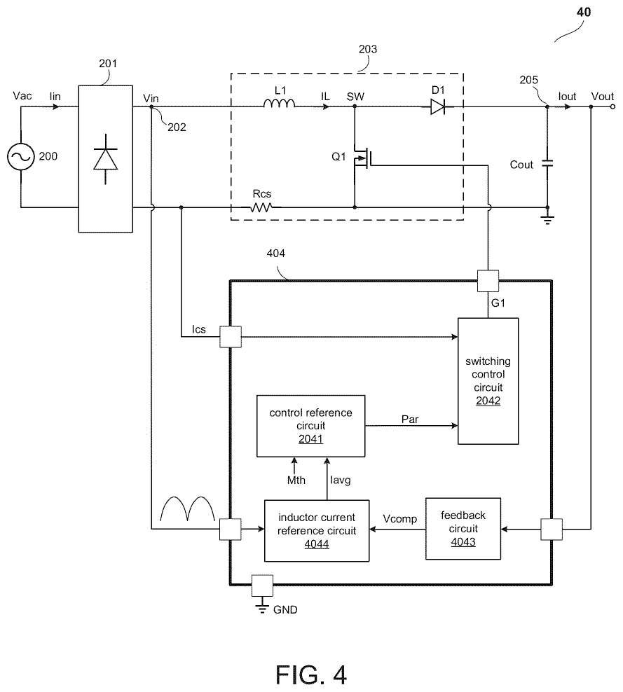

FIG. 4 schematically shows a PFC circuit 40 in accordance with an embodiment of the present invention. The PFC circuit 40 includes the rectifying circuit 201, the converting circuit 203, and a PF control circuit 404. The working principle of the PFC circuit 40 is similar to the PFC circuit 20 shown in FIG. 2. The difference is that, compared with the PFC circuit 20, the PFC circuit 40 further includes a feedback circuit 4043 and an inductor current reference circuit 4044.

The feedback circuit 4043 receives the output voltage Vout, and provides a feedback control signal Vcomp based on the output voltage Vout. In one embodiment, the feedback circuit 4043 includes an error amplifying circuit. The error amplifying circuit compares the output voltage Vout with an output voltage reference signal, and provides the feedback control signal Vcomp based on a comparison result of the output voltage Vout and the output voltage reference signal. The feedback control signal Vcomp reflects the load. In other embodiments, the feedback control signal may be generated based on the load current of the PFC circuit (the output current Iout of the PFC circuit) or the load power (the output power of the PFC circuit). Any suitable conventional circuits for generating the feedback control signal associated with the output voltage Vout or the circuit load could be used in the present invention. It should be appreciated that, in some embodiments, when the output voltage Vout is higher than an input voltage range of the feedback circuit 4043, the output voltage Vout may be provided to the feedback circuit 4043 through a voltage dividing circuit.

The inductor current reference circuit 4044 receives the input rectified voltage Vin and the feedback control signal Vcomp, and provides the inductor average current value Iavg based on the input rectified voltage Vin and the feedback control signal Vcomp. The waveform of the inductor average current Iavg follows the waveform of the input rectified voltage Vin, and the value of the inductor average current Iavg is determined by the feedback control signal Vcomp and the input rectified voltage Vin, which could be expressed as:

$$Iavg ( t ) = k 0 \times Vcomp \times Vin ( t ) \qquad ( 1 )$$

wherein Iavg(t) represents a real-time value of the inductor average current Iavg, Vin(t) represents a real-time value of the input rectified voltage Vin, and k0 represents a proportion factor corresponding to the ratio between the inductor current IL and the current sense signal Ics. In one embodiment, K0 is inversely proportional to the square of the peak value of the input rectified voltage Vin. As shown in equation (1), when the input rectified voltage Vin is determined (i.e., the AC voltage is determined), the value of the inductor average current Iavg is associated with the feedback control signal Vcomp. The feedback control signal Vcomp indicates the change of the load, thus the value of the inductor average current Iavg is also affected by the load. In one embodiment, the value of the feedback control signal Vcomp increases as the load increases and decreases as the load decreases. Therefore, combined with the equation (1), when the feedback control signal Vcomp increases to indicate that the load increases, the value of the inductor average current value Iavg increases; when the feedback control signal Vcomp decreases to indicate that the load decreases, the value of the inductor average current value Iavg decreases.

The embodiment of FIG. 4 shows one scheme for generating the inductor average current value Iavg. It should be appreciated that, the inductor average current value Iavg could be obtained by other methods. For example, the inductor average current value Iavg could be obtained by generating a half-sine wave signal with its frequency same as that of the input rectified voltage Vin, and then multiplying the half-sine wave signal by a proportional coefficient corresponding to the load.

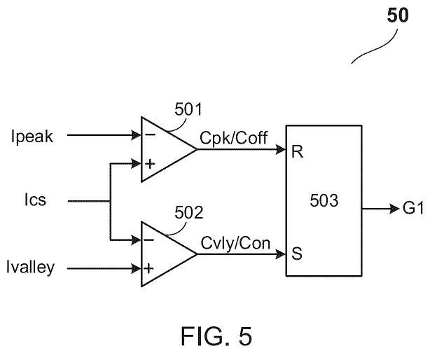

FIG. 5 schematically shows a switching control circuit 50 in accordance with an embodiment of the present invention. The switching control circuit 50 could be applied to realize the function of the switching control circuit 2042 of the embodiments of FIG. 2 and FIG. 4. As shown in FIG. 5, the switching control circuit 50 includes a peak comparing circuit 501, a valley comparing circuit 502 and a driving circuit 503.

The peak comparing circuit 501 receives the current sense signal Ics indicative of the inductor current IL and the current peak value Ipeak, and provides a peak control signal Cpk as a turn-off control signal Coff based on the current sense signal Ics and the current peak value Ipeak.

The valley comparing circuit 502 receives the current sense signal Ics indicative of the inductor current IL and the current valley value Ivalley, and provides a valley control signal Cvly as a turn-on control signal Con based on the current sense signal Ics and the current valley value Ivalley.

The driving circuit 503 receives the peak control signal Cpk and the valley control signal Cvly, and provides the switching control signal G1 based on the peak control signal Cpk and the valley control signal Cvly. In the embodiment of FIG. 3, the driving circuit 503 includes a RS flip-flop. When the peak control signal Cpk indicates that the current sense signal Ics reaches the current peak value Ipeak, the driving circuit 503 provides the switching control signal G1 to turn off the first switch Q1. When the valley control signal Cvly indicates that the current sense signal les decreases to the current valley value Ivalley, the driving circuit 503 provides the switching control signal G1 to turn on the first switch Q1. In some embodiments, to reduce a turn-on loss of the first switch Q1, after the current sense signal Ics decreases to the current valley value Ivalley, the first switch Q1 is turned on by the switching control signal G1 when a switching voltage Vsw reaches a valley. The switching voltage Vsw is a voltage at a switching terminal SW of the PFC circuit 40. In one embodiment, the driving circuit 503 further includes a driving capability amplifying circuit to enhance the driving capability of the switching control signal G1.

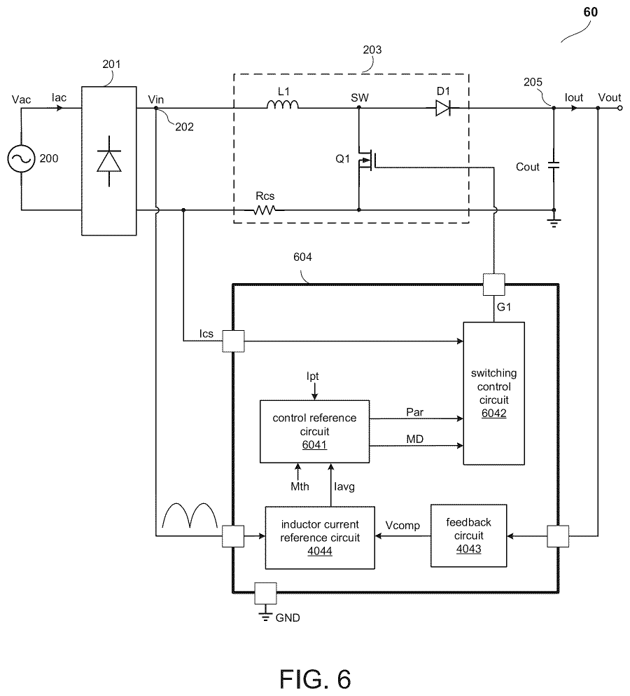

FIG. 6 schematically shows a PFC circuit 60 in accordance with an embodiment of the present invention. The PFC circuit 60 includes the rectifying circuit 201, the converting circuit 203, and a PF control circuit 604. The PF control circuit 604 includes a control reference circuit 6041 and a switching control circuit 6042. The control reference circuit 6041 receives the mode threshold Mth, the inductor average current value Iavg and a peak threshold Ipt, and provides the parameter control data Par and a mode control signal MD based on the mode threshold Mth, the inductor average current value Iavg, and the peak threshold Ipt. The switching control circuit 6042 receives the current sense signal Ics, the parameter control data Par and the mode control signal MD, and provides the switching control signal G1 to control the first switch Q1 of the PFC circuit 60 based on the current sense signal Ics, the parameter control data Par, and the mode control signal MD. The mode control signal MD indicates the working mode of the circuit. In the embodiment of FIG. 6, the mode control signal MD determines whether the circuit operates in DCM based on the peak value Iavgp of the inductor average current value Iavg and the peak threshold Ipt. As illustrated above, the inductor average current value Iavg could be replaced by other half-sine wave signal, for example, the input rectified voltage Vin. It should be appreciated that, the value of the peak threshold Ipt and the form of the signals should be adjusted along with different the half-sine wave signal for controlling the working mode of the circuit.

In some embodiment, the mode control signal MD may have different levels for indicating different working modes, for example, the mode control signal MD at high level may indicate CCM or BCM, at low level may indicate DCM. In other embodiments, the mode control signal MD may be a digital signal with multiple digits, for example, 00 may indicate CCM or BCM, 11 may indicate DCM, et. al. It should be appreciated that, the mode control signal MD may use other suitable signal forms to indicate difference working modes. In some embodiments, when the peak value Iavgp of the inductor average current value Iavg is smaller than the peak threshold Ipt, the mode control signal MD determines the PFC circuit 60 to operate in DCM. When the peak value Iavgp of the inductor average current value Iavg is larger than the peak threshold Ipt, and the inductor average current value Iavg is smaller than the mode threshold Mth, the mode control signal MD determines the PFC circuit 60 to operate in BCM. When the peak value Iavgp of the inductor average current value Iavg is larger than the peak threshold Ipt, and the inductor average current value Iavg is larger than the mode threshold Mth, the mode control signal MD determines the PFC circuit 60 to operate in CCM. In one embodiment, the peak threshold Ipt is smaller than the mode threshold Mth.

In the embodiment of FIG. 6, the parameter control data Par includes the current peak value Ipeak, the current valley value Ivalley, and a delay data Td.

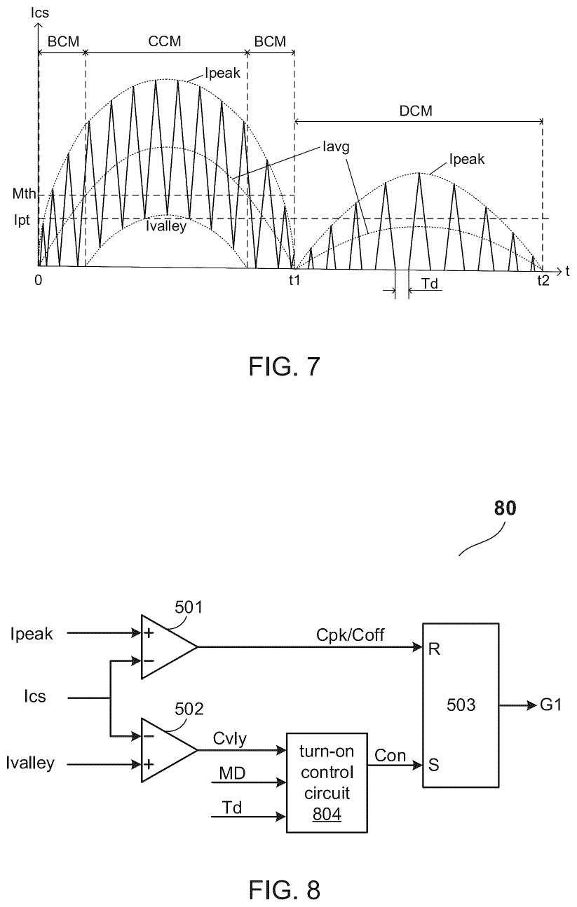

FIG. 7 schematically shows waveforms of the current sense signal Ics of the PFC circuit 60 operating under heavy load and light load in accordance with an embodiment of the present invention. To illustrate the working principle of the circuit operating under different loads, FIG. 7 shows a waveform of the current sense signal Ics in a single cycle (0−t1) under heavy load and a waveform of the current sense signal les in a single cycle (t1−t2) under light load respectively. It should be appreciated that, the heavy load cycle and the light load cycle are not necessarily adjacent in actual operation, and waveforms in FIG. 7 are just for illustration.

When the peak value Iavgp of the inductor average current value Iavg is smaller than the peak threshold Ipt, the PFC circuit 60 operates in DCM, as shown in time t1−t2 of FIG. 7. In DCM, the current valley value Ivalley is zero. In some embodiments, the current peak value Ipeak is:

$$Ipeak = 2 \times Iavg \times \frac{Ton + Toff + T d}{Ton + Toff} \qquad ( 2 )$$

wherein Ton represents an on-time period from when the first switch Q1 is turned on to when the second switch D1 is turned off, and Toff represents an off-time period from when the first switch Q1 is turned off to when the second switch D1 is turned on. The Td represents a value of the delay data, i.e., a time period during when the first switch Q1 and the second switch D1 are both turned off. In some embodiments, the value of the delay data Td is:

$$T d = Td max - k 1 \times IAvgp \qquad ( 3 )$$

wherein, Tdmax represents a maximum delay time according to specifications and requirements of practical applications, k1 represents a coefficient associated with the load. In one embodiment, k1−m×Vinpk, wherein Vinpk is the peak value of the input rectified voltage Vin, m is a constant coefficient.

It should be appreciated that, the value of the delay data Td could be obtained by different methods based on requirements. For example, when the feedback control signal Vcomp is determined, the value of the delay data Td could be obtained by: Td=Tdmax−k2×Vcomp, wherein k2 is a coefficient, which could be set according to specifications and requirements of practical applications.

When the current sense signal Ics increases to the current peak value Ipeak, the switching control signal G1 turns off the first switch Q1. After a time period indicated by the delay data Td is reached from the time when the current sense signal Ics indicates that the inductor current IL decreases to the current valley value Ivalley (e.g., zero), the switching control signal G1 turns on the first switch Q1.

In some embodiments, the PF control circuit 604 records the on-time periods of the first switch Q1 and the second switch D1 in every switching period respectively, and the off-time period of when the first switch Q1 and the second switch D1 are both turned off, and stores them in a registers to obtain the on-time period Ton, the off-time period Toff and the delay data Td. The on-time period Ton, the off-time period Toff, and the delay data Td are utilized for calculating the current peak value Ipeak of a next switching period. In one embodiment, the PF control circuit 604 includes a timing circuit to timing logic level durations of the turn-on control signal Con and the turn-off control signal Coff respectively. The logic level durations are associated with the on/off states of the first switch Q1 and the second switch D1.

When the peak value Iavgp of the inductor average current value Iavg is larger than the peak threshold Ipt, the working principle of the PFC circuit 60 is same as the PFC circuit 20. As shown in time 0−t1 of FIG. 7, when the inductor average current value Iavg is larger than the mode threshold Mth, the PFC circuit 60 operates in CCM. When the inductor average current value Iavg is smaller than the mode threshold Mth, the PFC circuit 20 operates in BCM. As illustrate above, when the inductor average current value Iavg is smaller than the peak threshold Ipt in the whole cycle, in other words, when the peak value Iavgp of the inductor average current value Iavg is between the mode threshold Mth and the peak threshold Ipt, the PFC circuit 60 operates in BCM.

In the embodiment of FIG. 6, the PF control circuit 604 further includes the feedback circuit 4043 and the inductor current reference circuit 4044, for providing the inductor average current value Iavg.

FIG. 8 schematically shows a switching control circuit 80 in accordance with an embodiment of the present invention. The switching control circuit 80 could be applied to realize the function of the switching control circuit 6042 in the embodiment of FIG. 6. As shown in FIG. 8, the switching control circuit 80 includes the peak comparing circuit 501, the valley comparing circuit 502, a turn-on control circuit 804, and the driving circuit 503.

The peak comparing circuit 501 receives the current sense signal Ics indicative of the inductor current IL and the current peak value Ipeak, and provides the peak control signal Cpk as the turn-off control signal Coff based on the current sense signal les and the current peak value Ipeak.

The valley comparing circuit 502 receives the current sense signal Ics indicative of the inductor current IL and the current valley value Ivalley, and provides the valley control signal Cvly based on the current sense signal Ics and the current valley value Ivalley.

The turn-on control circuit 804 receives the valley control signal Cvly, the mode control signal MD and the delay data Td, and provides the turn-on control signal Con based on the valley control signal Cvly, the mode control signal MD and the delay data Td. In CCM and BCM, the value of the delay data Td is zero, and when the valley control signal Cvly indicates that the current sense signal Ics decreases to the current valley value Ivalley, the turn-on control signal Con turns on the first switch Q1. As illustrated herein before, in some embodiments, in BCM, when the valley control signal Cvly indicates that the current sense signal Ics decreases to the current valley value Ivalley, to reduce the turn-on loss of the first switch Q1, the first switch Q1 is turned on when the switching voltage Vsw reaches the valley or when the switching voltage Vsw decreases to a zero-crossing threshold Vz. In one embodiment, the value of the zero-crossing threshold Vz is zero. In DCM, after the time period indicated by the delay data Td is reached from the time when the valley control signal Cvly indicates that the current sense signal Ics decreases to the current valley value Ivalley, the turn-on control signal Con turns on the first switch Q1.

In one embodiment, the turn-on control circuit 804 includes a timing circuit. The timing circuit starts timing when the current sense signal Ics decreases to the current valley value Ivalley. When the timing period is equal to the time period indicated by the delay data Td, the turn-on control signal 804 provides the turn-on control signal Con to turn on the first switch Q1.

The driving circuit 503 receives the turn-off control signal Coff and the turn-on control signal Con, and provides the switching control signal G1 based on the turn-off control signal Coff and the turn-on control signal Con. When the peak control signal Cpk indicates that the current sense signal Ics reaches the current peak value Ipeak, the driving circuit 503 provides the switching control signal G1 to turn off the first switch Q1. After the time period indicated by the delay data Td is reached from the time when the turn-on control signal Con indicates that the current sense signal Ics decreases to the current valley value Ivalley, the driving circuit 503 provides the switching control signal G1 to turn on the first switch Q1.

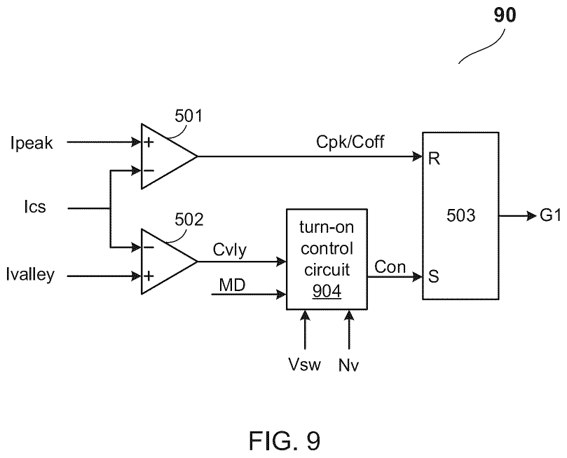

FIG. 9 schematically shows a switching control circuit 90 in accordance with an embodiment of the present invention. The switching control circuit 90 could be applied to realize the function of the switching control circuit 6042 in the embodiment of FIG. 6. As shown in FIG. 9, the switching control circuit 90 includes the peak comparing circuit 501, the valley comparing circuit 502, a turn-on control circuit 904 and the driving circuit 503.

The peak comparing circuit 501 receives the current sense signal Ics indicative of the inductor current IL and the current peak value Ipeak, and provides the peak value control signal Cpk as the turn-off control signal Coff based on the current sense signal Ics and the current peak value Ipeak.

The valley comparing circuit 502 receives the current sense signal Ics indicative of the inductor current Ics and the current valley value Ivalley, and provides the valley value control signal Cvly based on the current sense signal Ics and the current valley value Ivalley.

The turn-on control circuit 904 receives the valley value control signal Cvly, the mode control signal MD, the switching voltage Vsw and a valley number Nv, and provides the turn-on control signal Con based on the valley value control signal Cvly, the mode control signal MD, the switching voltage Vsw and the valley number Nv. In CCM, a value of the valley number Nv is zero, when the current sense signal Ics decreases to the current valley value Ivalley, the turn-on control signal Con turns on the first switch Q1. In BCM, the value of the valley number Nv may be 0, when the current sense signal Ics decreases to the current valley value Ivalley, the turn-on control signal Con turns on the first switch Q1. Alternatively, the value of the valley number Nv may be 1, when the current sense signal Ics decreases to the current valley value Ivalley, the first switch Q1 is turned on at a first valley of the switching voltage Vsw or the first switch Q1 is turned on when the switching voltage Vsw decreases to the zero-crossing threshold Vz, to reduce the turn-on loss of the first switch Q1. In DCM, when the current sense signal Ics decreases to the current valley value Ivalley, the switching voltage Vsw starts ringing. The turn-on control circuit 904 detects the ringing valley of the switching voltage Vsw. When the number of the ringing valley reaches the valley number Nv, the turn-on control signal Con turns on the first switch Q1.

In one embodiment, the turn-on control signal 904 includes a valley detecting circuit and a counting circuit. The valley detecting circuit detects the ringing valley of the switching voltage Vsw. The counting circuit counts the ringing valley of the switching voltage Vsw. When the number of the detected valley is equal to the valley number Nv, the turn-on control signal Con is provided to turn on the first switch Q1.

The valley number Nv may be included in the parameter control data Par. Persons having ordinary skill in the art could set the valley number Nv according to specifications and requirements of practical applications. In one embodiment, the valley number Nv could be expressed as:

$$N v = k 3 \times ( Ipt - Iavgp ) \qquad ( 4 )$$

wherein, k3 is a proportional coefficient which could be set according to specifications and requirements of practical applications.

The driving circuit 503 receives the turn-off control signal Coff and the turn-on control signal Con, and provides the switching control signal G1 based on the turn-off control signal Coff and the turn-on control signal Con. When the peak control signal Cpk indicates that the current sense signal Ics reaches the current peak value Ipeak, the driving circuit 503 provides the switching control signal G1 to turn off the first switch Q1. When the turn-on control signal Con indicates that the current sense signal Ics decreases to the current valley value Ivalley, and the valley number of the switching voltage Vsw is equal to the valley number Nv, the driving circuit 503 provides the switching control signal G1 to turn on the first switch Q1.

In the embodiment of FIG. 9, the current peak value Ipeak could be calculated based on the equation (2). The on-time period Ton, the off-time period Toff and the delay data Td could be obtained based on on-time periods and off-time periods of the first switch Q1 and the second switch D1 of a previous switching period.

It should be appreciated that, the values of the current peak value Ipeak and the current valley value Ivalley provided above are just for illustration purpose. In other embodiments of the present invention, the values of the current peak value Ipeak and the current valley value Ivalley could be different. For example, in some embodiments, the switching frequency of the main power switch is fixed, the values of the current peak value Ipeak and the current valley value Ivalley could be set based on the fixed switching frequency and the inductor average current value Iavg.

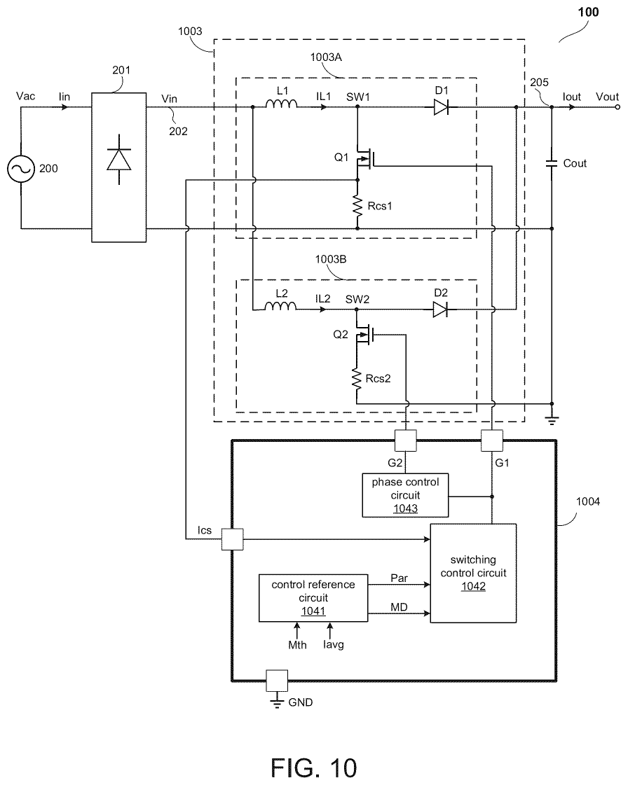

FIG. 10 schematically shows a PFC circuit 100 in accordance with an embodiment of the present invention. The PFC circuit 100 includes the rectifying circuit 201, a converting circuit 1003 and a PF control circuit 1004. Compared with the PFC circuit 20 shown in FIG. 2, in FIG. 10, the converting circuit 1003 has a two-phase interleaved parallel structure including a first phase 1003A and a second phase 1003B. The PF control circuit 1004 provides the switching control signal G1 and a switching control signal G2 for controlling the first phase 1003A and the second phase 1003B of the converting circuit 1003 respectively. The phase difference between the switching control signal G1 and the switching control signal G2 is 180°.

In the embodiment of FIG. 10, the switching control signal G2 is generated by shifting the phase of the switching control signal G1. Therefore, in the following description, the control method of the switching control signal G1 will be discussed. Accordingly, the switching voltage mentioned later refers to a voltage of a switching terminal SW1 of the first phase 1003A, the main power switch is the first switch Q1 of the first phase 1003A. It should be appreciated that, the phases of the switching control signal G2 and the switching control signal G1 are interlaced, in other embodiments, the phase difference between the switching control signal G2 and the switching control signal G1 could be set according to specs and requirements of the application. Meanwhile, any conventional phase-shifting circuit could be applied to generate the switching control signal G2 in the embodiments of the present invention.

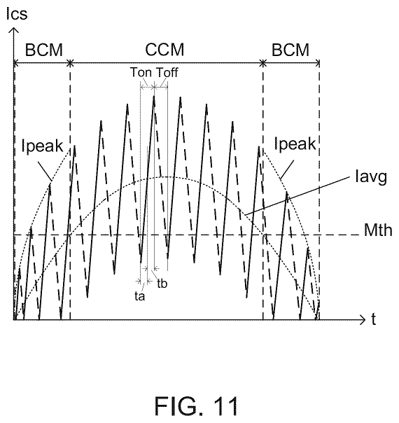

As shown in FIG. 10, a detecting resistor Rcs1 is coupled in series with the first switch Q1 to detect an inductor current IL1 of the first phase 1003A. In this case, when the first switch Q1 is turned on, a current flows through the detecting resistor Rcs1. In other words, as shown in FIG. 11, only the increasing part of the inductor current IL1 could be detected by the current sense signal Ics, the decreasing part of the inductor current IL1 is lacked. In FIG. 11, the solid line represents the part of the inductor current which the current sense signal Ics could detect, and the dotted line represents the part of the inductor current which the current sense signal Ics could not detect. Due to the lack of the decreasing part of the inductor current IL1, in the embodiment of FIG. 10, the first switch Q1 could not be turned on by setting the valley value current Ivalley.

In the embodiment of FIG. 10, the PF control circuit 1004 includes a control reference circuit 1041, a switching control circuit 1042 and a phase control circuit 1043. The control reference circuit 1041 receives the mode threshold Mth and the inductor average current value Iavg, and provides the parameter control data Par and the mode control signal MD. The parameter control data Par includes the current peak value Ipeak. The mode control signal MD indicates the working mode of the circuit, including CCM and BCM. The switching control circuit 1042 receives the current sense signal Ics, the parameter control data Par and the mode control signal MD, and provides the switching control signal G1 to control the first switch Q1 of the PFC circuit 100 based on the current sense signal Ics, the parameter control data Par and the mode control signal MD. The phase control circuit 1043 provides the switching control signal G2 based on the switching control signal G1 to control a second switch Q2 of the PFC circuit 100. When the inductor average current value Iavg is larger than the mode threshold Mth, the PFC circuit 20 operates in CCM, otherwise, the PFC circuit 20 operates in BCM. The first switch Q1 is a main power switch of the first phase 1003A of the converting circuit 1003, the second switch Q2 is a main power switch of the second phase 1003B of the converting circuit 1003.

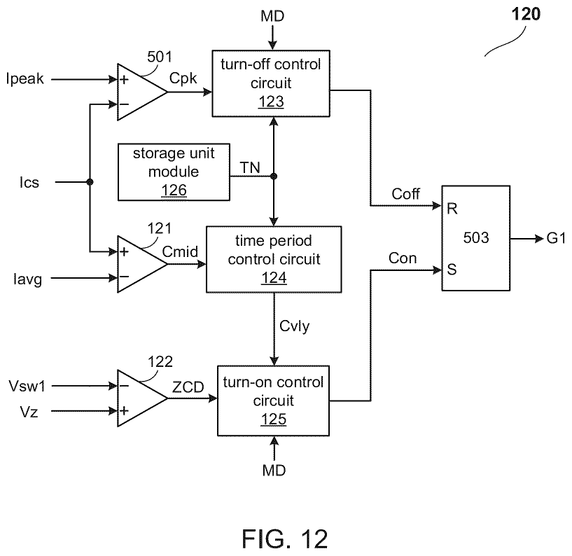

FIG. 11 schematically shows a waveform of the current sense signal Ics of the PFC circuit 100 in accordance with an embodiment of the present invention. As shown in FIG. 11, in the single cycle of the inductor average current value Iavg, when the inductor average current value Iavg is smaller than the mode threshold Mth, the PFC circuit 100 operates in BCM; when the inductor average current value Iavg is larger than the mode threshold Mth, the PFC circuit 100 operates in CCM. In BCM, when the value of the current sense signal Ics increases to the current peak value Ipeak, the switching control signal G1 turns off the first switch Q1; when the switching voltage Vsw1 of the switching terminal SW1 decreases to zero, the first switch Q1 is turned on. The value of the switching voltage Vsw1 could be obtained by directly detecting, detecting a voltage of an auxiliary winding coupled in parallel with the inductor L1, and other conventional methods. A zero-crossing point of the switching voltage Vsw1 could be obtained by detecting the switching voltage Vsw1 directly or using a slope detecting circuit to detecting the slew rate of the switching voltage Vsw1. In CCM, the on-time period Ton of the first switch Q1 is fixed to a time period indicated by an on-time period data TN, and the off-time period Toff of the first switch Q1 is adjusted based on a first time period ta and a second time period tb as shown in FIG. 11. The first time period ta starts from the time when the first switch Q1 is turned on, ends at the time when the current sense signal Ics increases to the inductor average current value Iavg. The second time period tb starts from the time when the current sense signal Ics increases to the inductor average current value Iavg, ends at the time when the on-time period Ton ends. The working principle of the switching control circuit 1042 is illustrated below in detail with reference to FIGS. 11 and 12.

FIG. 12 schematically shows a switching control circuit 120 in accordance with an embodiment of the present invention. The switching control circuit 120 could be applied to realize the function of the switching control circuit 1042 in the embodiment of FIG. 10. As shown in FIG. 12, the switching control circuit 120 includes the peak comparing circuit 501, an average current comparing circuit 121, a zero-crossing detecting circuit 122, a turn-off control circuit 123, a time period control circuit 124, a turn-on control circuit 125 and the driving circuit 503.

The peak comparing circuit 501 receives the current sense signal Ics indicative of the inductor current IL and the current peak value Ipeak, and provides the peak control signal Cpk based on the current sense signal Ics and the current peak value Ipeak.

The time period control circuit 124 receives an intermediate value control signal Cmid, and provides the valley control signal Cvly based on the intermediate value control signal Cmid and the on-time period data TN. In the embodiments of the present invention, the PF control circuit further includes a storage unit module 126. The on-time period Ton of the first switch Q1 in each switching period is recorded and stored in the storage unit module 126. The on-time period Ton of the first switch Q1 in the switching period before entering CCM (i.e., the circuit operates in BCM in this switching period) is recorded in the storage unit module 126 and is used as the on-time period data TN. In other words, in CCM, the on-time period Ton of the first switch Q1 is fixed to the time period determined by the on-time period data TN. In some embodiments, the on-time period data TN could be set by persons of ordinary skill in the art according to the requirements of the application. In the embodiment of FIG. 12, when the value of the current sense signal Ics is greater than the inductor average current value Iavg, the value of the intermediate value control signal Cmid is logic high, therefore, the value of the second time period tb shown in FIG. 11 could be obtained by detecting the intermediate value control signal Cmid. Combining the on-time period data TN and the second time period tb, the value of the first time period ta shown in FIG. 11 could be obtained. The time period control circuit 124 compares the value of the first time period ta and the value of the second time period tb, and provides the valley control signal Cvly based on a difference between the first time period ta and the second time period tb to adjust the off-time period Toff of the first switch Q1. In some embodiments, during CCM, the time period control circuit 124 starts timing after the on-time period Ton ends. When the timing duration reaches the off-time period Toff, the valley control signal Cvly indicates that the off-time period Toff ends, the turn-on control circuit 125 provides the turn-on control signal Con to turn on the first switch Q1. In one embodiment, when the first time period ta is greater than the second time period tb, or when a ratio of the first time period ta to the on-time period Ton exceeds 50%, the off-time period Toff is shortened, so that the first time period ta in the next period is shortened. When the first time period ta is smaller than the second time period tb, or when the ratio of the first time period ta to the on-time period Ton is smaller than 50%, the off-time period Toff is prolonged, thereby the first time period ta in the next period is prolonged. Through the above control, the value of the first time period ta is equal to the second time period tb, and the average value of the current sense signal Ics is controlled to follow the inductor average current value Iavg. In some embodiments, during CCM, an initial value of the off-time period Toff is 0. In other embodiments, during CCM, the initial value of the off-time period Toff is the off-time period of the first switch Q1 in the last switching period before entering CCM (i.e., the circuit operates in BCM before entering CCM).

It should be appreciated that, other detecting methods could be used to detect the first time period ta and the second time period tb. For example, a comparator may be used to detect a time period that the current sense signal Ics is smaller than the inductor average current value Iavg, i.e., the first time period ta, and then the second time period tb is calculated based on the on-time period data TN and the first time period ta. In some embodiments, the off-time period Toff of the first switch Q1 could be adjusted based on the difference between the first time period ta and the second time period tb. In other embodiments, the off-time period Toff of the first switch Q1 could also be adjusted based on a ratio between the first time period ta/the second time period tb and the on-time period data TN.

The turn-off control circuit 123 receives the peak value control signal Cpk, the on-time period data TN and the mode control signal MD, and provides the turn-off control signal Coff. When the mode control signal MD indicates that the circuit operates in CCM, and when the on-time period Ton of the first switch Q1 reaches the time period indicated by the on-time period data TN, the turn-off control signal Coff turns off the first switch Q1. When the mode control signal MD indicates that the circuit operates in BCM, when the peak control signal Cpk indicates that the current sense signal les reaches the current peak value Ipeak, the turn-off control signal Coff turns off the first switch Q1.

The zero-crossing detecting circuit 122 receives the switching voltage Vsw1 and the zero-crossing threshold Vz, and provides a zero-crossing control signal ZCD based on the switching voltage Vsw1 and the zero-crossing threshold Vz. In BCM, the zero-crossing detecting circuit 122 is enabled. In other words, in BCM, the zero-crossing control signal ZCD is selected as the turn-on control signal Con to turn on the first switch Q1. In BCM, when the value of the switching voltage Vsw1 decreases to 0, the zero-crossing control signal ZCD controls the turn-on control signal Con through the turn-on control circuit 125 to turn on the first switch Q1.

The turn-on control circuit 125 receives the zero-crossing control signal ZCD, the valley control signal Cvly and the mode control signal MD, and provides the turn-on control signal Con based on the zero-crossing control signal ZCD, the valley control signal Cvly, and the mode control signal MD. In one embodiment, in CCM, the valley control signal Cvly is selected as the turn-on control signal Con to turn on the first switch Q1; in BCM, the zero-crossing control signal ZCD is selected as the turn-on control signal Con to turn on the first switch Q1.

The driving circuit 503 receives the turn-off control signal Coff and the turn-on control signal Con, and provides the switching control signal G1 based on the turn-off control signal Coff and the turn-on control signal Con.

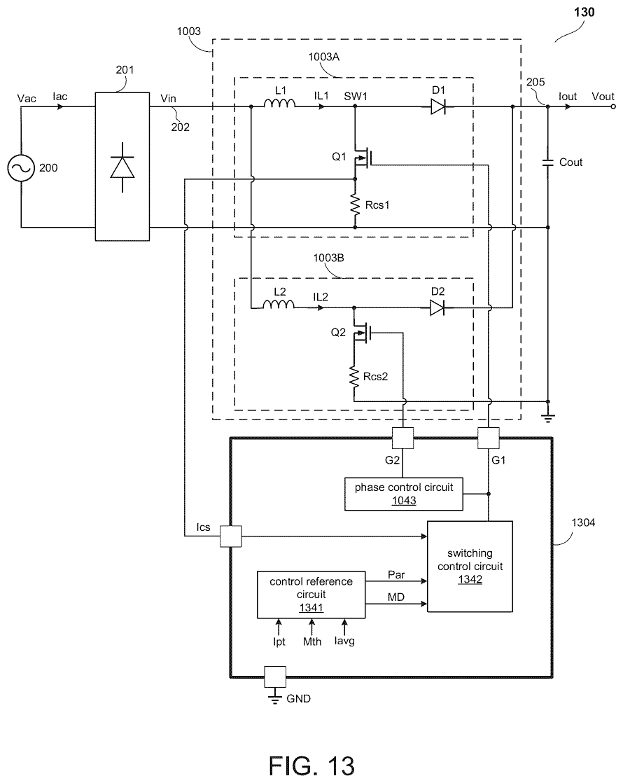

FIG. 13 schematically shows a PFC circuit 130 in accordance with an embodiment of the present invention. Different from the PFC circuit 100 shown in FIG. 10, the PFC circuit 130 could operate in DCM. The PFC circuit 130 includes a PF control circuit 1304. The PF control circuit 1304 includes a control reference circuit 1341, a switching control circuit 1342 and a phase control circuit 1043. The control reference circuit 1341 receives the mode threshold Mth, the peak threshold Ipt, and the inductor average current value Iavg, and provides the parameter control data Par and the mode control signal MD based on the mode threshold Mth, the peak threshold Ipt, and the inductor average current value Iavg. The parameter control data Par includes the current peak value Ipeak and the delay data Td, and the mode control signal MD indicates the working mode of the circuit, including CCM, BCM and DCM. The working mode of the PFC circuit 130 is determined based on the inductor average current value Iavg and the peak threshold Ipt. To be specific, in the single cycle of the input rectified voltage Vin, when the peak value of the inductor average current value Iavg is greater than the peak threshold Ipt, and the inductor average current value Iavg is greater than the mode threshold Mth, the PFC circuit 130 operates in CCM. When the peak value of the inductor average current value Iavg is greater than the peak threshold Ipt, and the inductor average current value Iavg is smaller than the mode threshold Mth, the PFC circuit 130 operates in BCM. When the peak value of the inductor average current value Iavg is smaller than the peak threshold Ipt, the PFC circuit 130 operates in DCM.

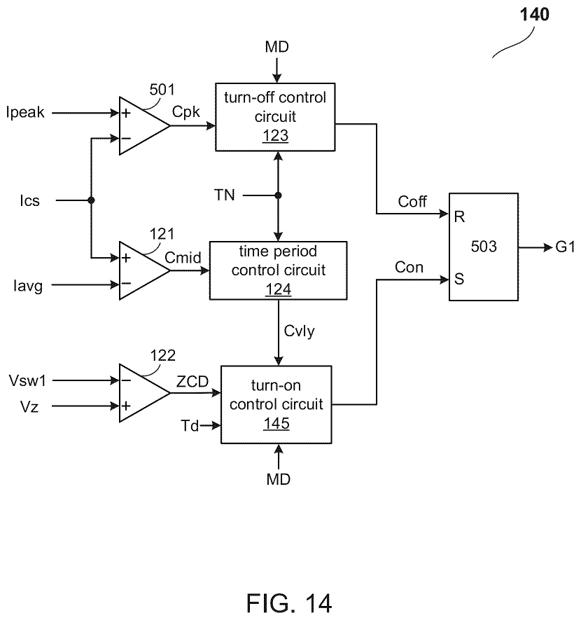

FIG. 14 schematically shows a switching control circuit 140 in accordance with an embodiment of the present invention. The switching control circuit 140 could be applied to realize the function of the switching control circuit 1342 in the embodiment of FIG. 13. As shown in FIG. 14, the switching control circuit 140 includes the peak comparing circuit 501, an average current comparing circuit 121, the zero-crossing detecting circuit 122, the turn-off control circuit 123, the time period control circuit 124, a turn-on control circuit 145 and the driving circuit 503.

Compared with the switching control circuit 120 shown in FIG. 12, the switching control circuit 140 could control the first switch Q1 in DCM, in other words, the working condition of the turn-on control circuit 145 is different from the turn-on control circuit 125 of the switching control circuit 120. When the mode control signal MD indicates that the circuit operates in CCM and BCM, the working condition of the turn-on control circuit 145 is same as the turn-on control circuit 125. When the mode control signal MD indicates that the circuit operates in DCM, after the time period indicated by the delay data Td is reached from the time when the zero-crossing control signal ZCD indicates that the switching voltage Vsw1 decreases to the zero-crossing threshold Vz, the turn-on control circuit 145 provides the turn-on control signal Con to turn on the first switch Q1. Similarly, in DCM, when the value of the current sense signal Ics increases to the current peak value Ipeak, the peak control signal Cpk is selected as the turn-off control signal Coff to turn off the first switch Q1. The working condition of other circuits of the switching control circuit 140 is same as the switching control circuit 120, and descriptions thereof are omitted here.

It should be appreciated that, in the embodiments of FIG. 10 and FIG. 13, the two-phase interleaved parallel converting circuit 1003 is used as an example to illustrate the control method of the PFC circuit when the decreasing part of the inductor current IL could not be detected. It should be appreciated that, the embodiments of the present invention are also applicable to other single-phase PFC circuits that could not detect the full waveform of the input current or inductor current, or PFC circuits that utilize multi-phase interleaved parallel converting circuit. To be specific, after generating the switching control signal of one phase of the converting circuit, the phase-shifting circuit could be used to generate the switching control signal of other phases thus to control the multi-phase interleaved parallel converting circuit. Certainly, PFC circuits that could detect the full waveform of the input current/the inductor current could also be applied to the embodiments of the present invention.

In the embodiments of the present invention, the PF control circuit 204, 404, 604, 1004, 1304 could be realized by a digital circuit. The functions of the modules and the relationships of the signals mentioned above could be described by a digital language, to generate the digital circuit automatically to realize the PF control circuit 204, 404, 604, 1004, 1304.

In some embodiments, the values of the mode threshold Mth, the peak threshold Ipt, the current reference Iref, and the like could be set via a register. In some embodiments, the values of the mode threshold Mth, the peak threshold Ipt, the current reference Iref, and the like could be set through an off-chip device, for example, a resistor and/or a capacitor et. al.

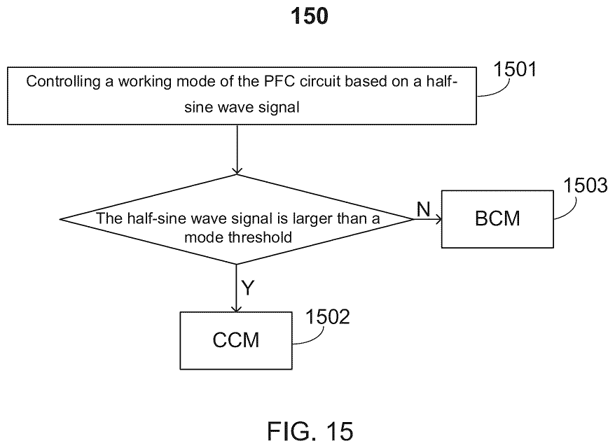

FIG. 15 schematically shows a flowchart of a control method 150 for controlling a PFC circuit in accordance with an embodiment of the present invention. The PFC circuit may be the converting circuit 203, the converting circuit 1003 and other converting circuits having different topologies. The control method 150 includes steps 1501-1503.

In step 1501, controlling a working mode of the PFC circuit based on a half-sine wave signal, a frequency of the half-sine wave signal is equal to a frequency of an input rectified voltage of the PFC circuit.

In step 1502, in a single cycle of the half-sine wave signal, when a value of the half-sine wave signal is larger than a mode threshold, the PFC circuit operates in CCM, otherwise, go to step 1503.

In step 1503, in the single cycle of the half-sine wave signal, when the value of the half-sine wave signal is smaller than the mode threshold, the PFC circuit operates in BCM.

The half-sine wave signal includes at least one of the input rectified voltage, an inductor average current value, a rectified signal of an AC voltage, and a rectified signal of an input current of the PFC circuit. It should be appreciated that, when one of the input rectified voltage, the inductor average current value, the rectified signal of an AC voltage and the rectified signal of the input current of the PFC circuit is selected as the half-sine wave signal, the mode threshold should be adjusted to a corresponding current value or voltage value. The input rectified voltage is obtained by rectifying the AC voltage. In some embodiments, a waveform of the input rectified voltage is substantially same as a positive half-sine wave.

In one embodiment, in CCM, turning off a main power switch of the PFC circuit when a current sense signal indicative of an inductor current of the PFC circuit increases to a current peak value; and turning on the main power switch of the PFC circuit when the current sense signal decreases to a current valley value.

In one embodiment, in CCM, a difference between the current peak value and the current valley value is constant.

In one embodiment, in CCM, a value of the current peak value is equal to a sum of a current reference and the inductor average current value, a value of the current valley value is equal to a difference between the current reference and the inductor average current value. In some embodiments, the current reference is a fixed value, persons skilled in the art could set the current reference according to specifications and requirements of practical applications. In one embodiment, the current reference is equal to the mode threshold.

In one embodiment, in CCM, turning off the main power switch of the PFC circuit when an on-time period of the main power switch reaches a time period indicated by an on-time period data. Detecting a first time period from when the main power switch is turned on to when the current sense signal increases to the inductor average current value. Regulating an off-time period of the main power switch of the PFC circuit based on the first time period and the on-time period data. Turning on the main power switch based on the off-time period of the main power switch. The current sense signal indicates the inductor current of the PFC circuit.

In one embodiment, in CCM, turning off the main power switch of the PFC circuit when the on-time period of the main power switch reaches the time period indicated by the on-time period data. Detecting a second time period from when the current sense signal starts increasing from the inductor average current value to when the main power switch is turned off. Regulating the off-time period of the main power switch of the PFC circuit based on the second time period and the on-time period data. Turning on the main power switch based on the off-time period of the main power switch. The current sense signal indicates the inductor current of the PFC circuit.

In one embodiment, the on-time period data is generated based on the on-time period of the main power switch of a switching period before entering CCM.

In one embodiment, the on-time period data is set according to requirements of practical applications.

In one embodiment, an initial value of the off-time period is generated based on the off-time period of the main power switch of the switching period before entering CCM.

In one embodiment, the initial value of the off-time period is zero.

The input rectified voltage is obtained by rectifying the AC voltage by the rectifying circuit. In some embodiments, the waveform of the input rectified voltage is substantially same as the positive half-sine wave signal.

In one embodiment, in BCM, turning off the main power switch of the PFC circuit when the inductor current of the PFC circuit increases to the current peak value; turning on the main power switch of the PFC circuit when the inductor current of the PFC circuit decreases to zero. In other words, in BCM, the current valley value is zero.

In one embodiment, to reduce a turn-on loss of the main power switch, in BCM, after the inductor current of the PFC circuit decreases to zero, turning on the main power switch at a first valley of a switching voltage or when the switching voltage decreases to a zero-crossing threshold. The switching voltage is a voltage at a switching terminal of the PFC circuit, the zero-crossing threshold is equal to or close to zero.

In one embodiment, in BCM, turning off the main power switch of the PFC circuit when the inductor current of the PFC circuit increases to the current peak value; turning on the main power switch of the PFC circuit when the switching voltage of the PFC circuit decreases to zero. The switching voltage is the voltage at the switching terminal of the PFC circuit or the voltage at the switching terminal of a phase where the main power switch is located.

In one embodiment, in BCM, the value of the current peak value is twice of the inductor average current value.

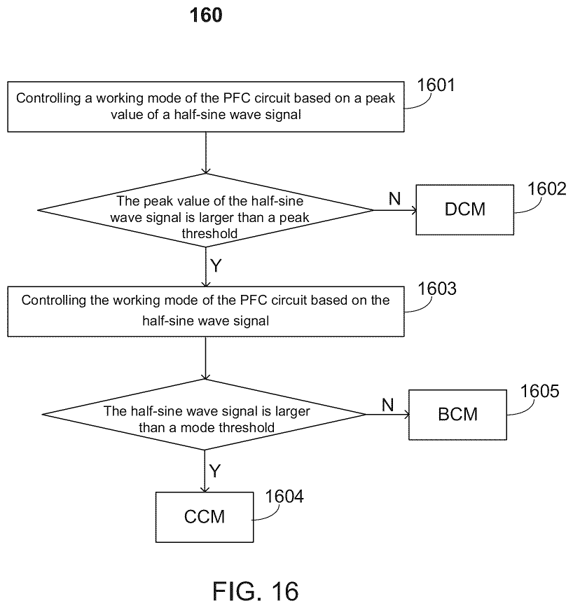

FIG. 16 schematically shows a flowchart of a control method 160 for controlling a PFC circuit in accordance with an embodiment of the present invention. The PFC circuit may be the converting circuit 203, the converting circuit 1003 and other converting circuits having different topologies. The control method 160 includes steps 1601-1605.

In step 1601, controlling a working mode of the PFC circuit based on a peak value of a half-sine wave signal, a frequency of the half-sine wave signal is equal to a frequency of an input rectified voltage of the PFC circuit.

In step 1602, in a single cycle of the half-sine wave signal, when a peak value of the half-sine wave signal is smaller than a peak threshold, the PFC circuit operates in DCM.

In step 1603, in a single cycle of the half-sine wave signal, when the peak value of the half-sine wave signal is larger than the peak threshold, the working mode of the PFC circuit is controlled based on a value of the half-sine wave signal.

In step 1604, in a single cycle of the half-sine wave signal, when the value of the half-sine wave signal is larger than a mode threshold, the PFC circuit operates in CCM.

In step 1605, in a single cycle of the half-sine wave signal, when the value of the half-sine wave signal is smaller than the mode threshold, the PFC circuit operates in BCM.

The half-sine wave signal includes at least one of the input rectified voltage, an inductor average current value, a rectified signal of an AC voltage and a rectified signal of an input current of the PFC circuit. It should be appreciated that, when one of the input rectified voltage, the inductor average current value, the rectified signal of an AC voltage and the rectified signal of the input current of the PFC circuit is selected as the half-sine wave signal, the mode threshold and the peak threshold should be adjusted to a corresponding value.

In one embodiment, in CCM, turning off a main power switch of the PFC circuit when an inductor current of the PFC circuit increases to a current peak value; turning on the main power switch of the PFC circuit when the inductor current of the PFC circuit decreases to a current valley value.

In one embodiment, in CCM, a difference between the current peak value and the current valley value is constant.

In one embodiment, in CCM, a value of the current peak value is equal to a sum of a current reference and the inductor average current value, a value of the current valley value is equal to a difference between the current reference and the inductor average current value. In some embodiments, the current reference is a fixed value, persons skilled in the art could set the current reference according to specifications and requirements of practical applications.

In one embodiment, in CCM, turning off the main power switch of the PFC circuit when an on-time period of the main power switch reaches a time period indicated by an on-time period data. Detecting a first time period from when the main power switch is turned on to when the current sense signal increases to the inductor average current value. Regulating an off-time period of the main power switch of the PFC circuit based on the first time period and the on-time period data. Turning on the main power switch based on the off-time period of the main power switch. The current sense signal indicates the inductor current of the PFC circuit.

In one embodiment, in CCM, turning off the main power switch of the PFC circuit when the on-time period of the main power switch reaches the time period indicated by the on-time period data. Detecting a second time period from when the current sense signal starts increasing from the inductor average current value to when the main power switch is turned off. Regulating the off-time period of the main power switch of the PFC circuit based on the second time period and the on-time period data. Turning on the main power switch based on the off-time period of the main power switch. The current sense signal indicates the inductor current of the PFC circuit.

In one embodiment, the on-time period data is generated based on the on-time period of the main power switch of a switching period before entering CCM.

In one embodiment, the on-time period data is set according to requirements of practical applications.

In one embodiment, an initial value of the off-time period is generated based on the off-time period of the main power switch of the switching period before entering CCM.

In one embodiment, the initial value of the off-time period is zero.

The input rectified voltage is obtained by rectifying the AC voltage through the rectifying circuit. In some embodiments, a waveform of the input rectified voltage is substantially same as a positive half-sine wave signal.

In one embodiment, in BCM, turning off the main power switch of the PFC circuit when the inductor current of the PFC circuit increases to the current peak value; turning on the main power switch of the PFC circuit when the inductor current of the PFC circuit decreases to zero. In other words, in BCM, the current valley value is zero.

In one embodiment, to reduce a turn-on loss of the main power switch, in BCM, after the inductor current of the PFC circuit decreases to zero, turning on the main power switch at a first valley of a switching voltage or when the switching voltage decreases to a zero-crossing threshold. The switching voltage is a voltage at a switching terminal of the PFC circuit, the zero-crossing threshold is equal to or close to zero.

In one embodiment, in BCM, turning off the main power switch of the PFC circuit when the inductor current of the PFC circuit increases to the current peak value; turning on the main power switch of the PFC circuit when the switching voltage of the PFC circuit decreases to zero.

In one embodiment, in BCM, the value of the current peak value is twice of the inductor average current value.

In one embodiment, in DCM, turning off the main power switch of the PFC circuit when the inductor current of the PFC circuit increases to the current peak value; turning on the main power switch of the PFC circuit when a time period indicated by a delay data is reached from the time when the inductor current of the PFC circuit decreases to zero.

In one embodiment, to reduce the turn-on loss of the main power switch, in DCM, after the time period indicated by the delay data is reached from the time when the inductor current of the PFC circuit decreases to zero, turning on the main power switch at a first valley of the switching voltage or when the switching voltage decreases to the zero-crossing threshold. The switching voltage is the voltage at the switching terminal of the PFC circuit, the zero-crossing threshold is equal to or close to zero.

In one embodiment, in DCM, turning off the main power switch of the PFC circuit when the inductor current of the PFC circuit increases to the current peak value. When the inductor current of the PFC circuit decreases to zero, and a number of valleys generated by ringing of the switching voltage reaches a valley number, turning on the main power switch of the PFC circuit.

In some embodiment, in DCM, a value of the valley number is set according to equation (4).

In some embodiment, in DCM, the peak value is set according to equation (2), the current valley value is zero.

In one embodiment, in DCM, turning off the main power switch of the PFC circuit when the inductor current of the PFC circuit increases to the current peak value. After the time period indicated by the delay data is reached from the time when the switching voltage of the PFC circuit decreases to zero, turning on the main power switch of the PFC circuit.

In some embodiment, in DCM, the value of the delay data is set according to equation (3).

In some embodiments, the aforementioned control methods 150 and 160 further include two steps: providing a feedback control signal to indicate a load of the PF control circuit; and providing the inductor average current value based on the feedback control signal and the input rectified voltage. The inductor average current value is proportional to the product of the feedback control signal and a real-time value of the input rectified voltage, and inversely proportional to the square of the peak value of the input rectified voltage. It should be appreciated that, in other embodiments, the inductor average current value could also be obtained by other methods, for example, by generating a half-sine wave having a frequency that is consistent with the frequency of the input rectified voltage Vin, and then multiplying the half-sine wave by a proportional coefficient corresponding to the load. Moreover, in other embodiments, the feedback control signal may also be provided based on a load current or a load power of the PFC circuit. It should be appreciated that, the feedback control signal indicates the load of the PFC circuit, and any signal that could indicate the size and change of the load could be used as the feedback control signal. For example, in one embodiment, the feedback control signal could be generated based on an output voltage of the PFC circuit.

It should be appreciated that, the circuit and the workflow provided in the present invention are just for schematic illustration. Any circuits could realize the function and operation of the present invention does not depart from the spirit and the scope of the invention.

Although the invention has been described with reference to several exemplary embodiments, it should be appreciated that by persons skilled in the art that the present invention is not limited to what has been particularly shown and described herein above. Rather the scope of the present invention is defined by the claims and includes both combinations and sub-combinations of the various features described hereinabove as well as variations and modifications thereof which would occur to persons skilled in the art upon reading the foregoing description and which are not in the prior art.

What is claimed is:

1. A control circuit for controlling a PFC (Power Factor Correction) circuit, the control circuit comprising:
a control reference circuit configured to receive a mode threshold and a half-sine wave signal, and to provide a parameter control data based on the mode threshold and the half-sine wave signal; and
a switching control circuit configured to receive a current sense signal and the parameter control data, and to provide a switching control signal to control a main power switch of the PFC circuit based on the current sense signal and the parameter control data, wherein the current sense signal is indicative of a current flowing through an energy storage device of the PFC circuit; and
wherein in a single cycle of an input rectified voltage, when the half-sine wave signal is larger than the mode threshold, the control circuit operates in CCM (Continuous Current Mode), when the half-sine wave signal is smaller than the mode threshold, the control circuit operates in BCM (Boundary Conduction Mode), wherein the input rectified voltage is configured to be obtained by rectifying an AC voltage received by the PFC circuit.

2. The control circuit of claim 1, wherein the half-sine wave signal comprises at least one of the input rectified voltage, a current obtained by rectifying an input current, and an inductor average current value.

3. The control circuit of claim 2, wherein:
the parameter control data comprises a current peak value and a current valley value; and
wherein the switching control circuit comprises:
a peak value comparing circuit configured to receive the current sense signal and the current peak value, and to provide a peak control signal to turn off the main power switch based on the current sense signal and the current peak value; and
a valley value comparing circuit configured to receive the current sense signal and the current valley value, and to provide a valley control signal to turn on the main power switch based on the current sense signal and the current valley value; and
wherein in BCM, the main power switch is turned on when: (1) the current sense signal reaches the current valley value; (2) a switching voltage of the PFC circuit decreases to a zero-crossing threshold, wherein the switching voltage is a voltage of a switching terminal of the PFC circuit.

4. The control circuit of claim 1, wherein the control reference circuit is further configured to receive a peak threshold, and to provide the parameter control data and a mode control signal based on the mode threshold, the half-sine wave signal and the peak threshold, wherein when a peak value of the half-sine wave signal is smaller than the peak threshold, the control circuit operates in DCM (Discontinuous Conduction Mode).

5. The control circuit of claim 4, wherein:
the parameter control data comprises a current peak value, a current valley value, and a delay data; and
wherein the switching control circuit comprises:
a peak value comparing circuit configured to receive the current sense signal and the current peak value, and to provide a peak control signal to turn off the main power switch based on the current sense signal and the current peak value;
a valley value comparing circuit configured to receive the current sense signal and the current valley value, and to provide a valley control signal based on the current sense signal and the current valley value; and
a turn-on control circuit configured to receive the valley control signal, the mode control signal and the delay data, and to provide a turn-on control signal to turn on the main power switch based on the valley control signal, the mode control signal and the delay data; and
wherein the main power switch is turned on when: (1) the current sense signal reaches the current valley value; (2) a time period indicated by the delay data is reached from the time when the current sense signal reaches the current valley value; and
wherein in BCM, the main power switch is turned on when: (1) the current sense signal reaches the current valley value; (2) a switching voltage of the PFC circuit decreases to a zero-crossing threshold, wherein the switching voltage is a voltage of a switching terminal of the PFC circuit.

6. The control circuit of claim 4, wherein:
the parameter control data comprises a current peak value, a current valley value, and a valley number; and
wherein the switching control circuit comprises:
a peak value comparing circuit configured to receive the current sense signal and the current peak value, and to provide a peak control signal to turn off the main power switch based on the current sense signal and the current peak value;
a valley value comparing circuit configured to receive the current sense signal and the current valley value, and to provide a valley control signal based on the current sense signal and the current valley value; and
a turn-on control circuit configured to receive the valley control signal, the mode control signal, a switching voltage and the valley number, and to provide a turn-on control signal to turn on the main power switch based on the valley control signal, the mode control signal, the switching voltage and the valley number; and
wherein the main power switch is turned on when: (1) the current sense signal reaches the current valley value; (2) a number of ringing valleys of the switching voltage reaches the valley number, wherein the number of ringing valleys is counted from the time when the current sense signal reaches the current valley value; and
wherein the switching voltage is a voltage of a switching terminal of the PFC circuit.

7. The control circuit of claim 1, wherein:
the parameter control data comprises a current peak value; and
wherein the switching control circuit comprises:
a peak value comparing circuit configured to receive the current sense signal and the current peak value, and to provide a peak control signal to turn off the main power switch based on the current sense signal and the current peak value;
an average current comparing circuit configured to receive the current sense signal and an inductor average current value, and to provide an intermediate value control signal based on the current sense signal and the inductor average current value;
a time period control circuit configured to receive the intermediate value control signal and an on-time period data, and to provide a valley value control signal based on the intermediate value control signal and the on-time period data;
a zero-crossing detecting signal configured to receive a switching voltage of the PFC circuit and a zero-crossing threshold, and to provide a zero-crossing control signal based on the switching voltage and the zero-crossing threshold;
a turn-off control circuit configured to receive the peak value control signal, the on-time period data and a mode control signal, and to provide a turn-off control signal based on the peak value control signal, the on-time period data and the mode control signal; and
a turn-on control circuit configured to receive the zero-crossing control signal, the valley control signal and the mode control signal, and to provide a turn-on control signal based on the zero-crossing control signal, the valley control signal and the mode control signal; and
wherein in CCM, the main power switch is turned on when the valley control signal indicates that an off-time period of the main power switch ends, and the main power switch is turned off by the turn-off control signal when an on-time period of the main power switch reaches a time period indicated by the on-time period data; and
wherein in BCM, the main power switch is turned on by the turn-on control signal when the switching voltage decreases to the zero-crossing threshold, and the main power switch is turned off by the turn-off control signal when the peak control signal indicates that the current sense signal reaches the current peak value.

8. The control circuit of claim 7, wherein:
the turn-on control circuit is further configured to receive a delay data, in DCM, after the zero-crossing control signal indicates that the switching voltage decreases to the zero-crossing threshold, the main power switch is turned on by the turn-on control signal when a time period indicated by the delay data is reached.

9. The control circuit of claim 2, further comprising:
a feedback circuit configured to provide a feedback control signal based on a load of the PFC circuit; and
an inductor current reference circuit configured to receive the feedback control signal and the input rectified voltage of the PFC circuit, and to provide the inductor average current value based on the feedback control signal and the input rectified voltage of the PFC circuit.

10. The control circuit of claim 3, wherein:
in CCM, a difference between the current peak value and the current valley value is constant; and
in BCM, the current peak value is twice of the inductor average current value.

11. A PFC circuit, comprising:
a converting circuit;
a rectifying circuit configured to rectify an AC voltage provided by an AC power supply to obtain an input rectified voltage, and provide the input rectified voltage to an input terminal of the converting circuit; and
a control circuit configured to provide a switching control signal to control a main power switch of the converting circuit, the control circuit comprising:
a control reference circuit configured to receive a mode threshold and a half-sine wave signal, and to provide a parameter control data based on the mode threshold and the half-sine wave signal; and
a switching control circuit configured to receive a current sense signal and the parameter control data, and to provide a switching control signal to control the main power switch of the PFC circuit based on the current sense signal and the parameter control data, wherein the current sense signal is indicative of a current flowing through an energy storage device of the PFC circuit; and
wherein in a single cycle of the input rectified voltage, when the half-sine wave signal is larger than the mode threshold, the control circuit operates in CCM, when the half-sine wave signal is smaller than the mode threshold, the control circuit operates in BCM.

12. The PFC circuit of claim 11, wherein the half-sine wave signal comprises at least one of the input rectified voltage, a current obtained by rectifying an input current and an inductor average current value.

13. The PFC circuit of claim 12, wherein:
the parameter control data comprises a current peak value and a current valley value; and
wherein the switching control circuit comprises:
a peak value comparing circuit configured to receive the current sense signal and the current peak value, and to provide a peak control signal to turn off the main power switch based on the current sense signal and the current peak value; and
a valley value comparing circuit configured to receive the current sense signal and the current valley value, and to provide a valley control signal to turn on the main power switch based on the current sense signal and the current valley value; and
wherein in BCM, the main power switch is turned on when: (1) the current sense signal reaches the current valley value; (2) a switching voltage of the PFC circuit decreases to a zero-crossing threshold, wherein the switching voltage is a voltage of a switching terminal of the PFC circuit.

14. The PFC circuit of claim 11, wherein the control reference circuit is further configured to receive a peak threshold, and to provide the parameter control data and a mode control signal based on the mode threshold, the half-sine wave signal and the peak threshold, wherein when a peak value of the half-sine wave signal is smaller than the peak threshold, the control circuit operates in DCM.

15. The PFC circuit of claim 14, wherein:
the parameter control data comprises a current peak value, a current valley value, and a delay data; and
wherein the switching control circuit comprises:
a peak value comparing circuit configured to receive the current sense signal and the current peak value, and to provide a peak control signal to turn off the main power switch based on the current sense signal and the current peak value;
a valley value comparing circuit configured to receive the current sense signal and the current valley value, and to provide a valley control signal based on the current sense signal and the current valley value; and
a turn-on control circuit configured to receive the valley control signal, the mode control signal and the delay data, and to provide a turn-on control signal to turn on the main power switch based on the valley control signal, the mode control signal and the delay data; and
wherein the main power switch is turned on when: (1) the current sense signal reaches the current valley value; (2) a time period indicated by the delay data is reached from the time when the current sense signal reaches the current valley value; and
wherein in BCM, the main power switch is turned on when: (1) the current sense signal reaches the current valley value; (2) a switching voltage of the PFC circuit decreases to a zero-crossing threshold, wherein the switching voltage is a voltage of a switching terminal of the PFC circuit.

16. The PFC circuit of claim 14, wherein:
the parameter control data comprises a current peak value, a current valley value, and a valley number; and
wherein the switching control circuit comprises:
a peak value comparing circuit configured to receive the current sense signal and the current peak value, and to provide a peak control signal to turn off the main power switch based on the current sense signal and the current peak value;
a valley value comparing circuit configured to receive the current sense signal and the current valley value, and to provide a valley control signal based on the current sense signal and the current valley value; and
a turn-on control circuit configured to receive the valley control signal, the mode control signal, a switching voltage and the valley number, and to provide a turn-on control signal to turn on the main power switch based on the valley control signal, the mode control signal, the switching voltage and the valley number; and
wherein the main power switch is turned on when: (1) the current sense signal reaches the current valley value; (2) a number of ringing valleys of the switching voltage reaches the valley number, wherein the number of ringing valleys is counted from the time when the current sense signal reaches the current valley value; and
wherein the switching voltage is a voltage of a switching terminal of the PFC circuit.

17. The PFC circuit of claim 11, wherein:
the parameter control data comprises a current peak value; and
wherein the switching control circuit comprises:
a peak value comparing circuit configured to receive the current sense signal and the current peak value, and to provide a peak control signal to turn off the main power switch based on the current sense signal and the current peak value;
an average current comparing circuit configured to receive the current sense signal and an inductor average current value, and to provide an intermediate value control signal based on the current sense signal and the inductor average current value;
a time period control circuit configured to receive the intermediate value control signal and an on-time period data, and to provide a valley value control signal based on the intermediate value control signal and the on-time period data;
a zero-crossing detecting signal configured to receive a switching voltage of the PFC circuit and a zero-crossing threshold, and to provide a zero-crossing control signal based on the switching voltage and the zero-crossing threshold;
a turn-off control circuit configured to receive the peak value control signal, the on-time period data, and a mode control signal, and to provide a turn-off control signal based on the peak value control signal, the on-time period data, and the mode control signal; and
a turn-on control circuit configured to receive the zero-crossing control signal, the valley control signal, and the mode control signal, and to provide a turn-on control signal based on the zero-crossing control signal, the valley control signal, and the mode control signal; and
wherein in CCM, the main power switch is turned on when the valley control signal indicates that an off-time period of the main power switch ends, and the main power switch is turned off by the turn-off control signal when an on-time period of the main power switch reaches a time period indicated by the on-time period data; and
wherein in BCM, the main power switch is turned on by the turn-on control signal when the switching voltage decreases to the zero-crossing threshold, and the main power switch is turned off by the turn-off control signal when the peak control signal indicates that the current sense signal reaches the current peak value.

18. The PFC circuit of claim 17, wherein:
the turn-on control circuit is further configured to receive a delay data, in DCM, after the zero-crossing control signal indicates that the switching voltage decreases to the zero-crossing threshold, the main power switch is turned on by the turn-on control signal when a time period indicated by the delay data is reached.

19. The PFC circuit of claim 11, wherein the converting circuit comprises:
the energy storage device coupled between the input terminal of the converting circuit and a switching terminal;
the main power switch coupled between the switching terminal and a ground reference; and
a slave power switch coupled between the switching terminal and an output terminal of the converting circuit; and
wherein the input terminal of the converting circuit is configured to receive the input rectified voltage, the output terminal of the converting circuit is configured to provide an output voltage.

20. A control method for controlling a PFC circuit, comprising:
in a single cycle of a half-sine wave signal, when the half-sine wave signal is larger than a mode threshold, the PFC circuit operates in CCM; and
in a single cycle of the half-sine wave signal, when the half-sine wave signal is smaller than the mode threshold, the PFC circuit operates in BCM; and
wherein a frequency of the half-sine wave signal is twice of a frequency of an AC voltage.

21. The control method of claim 20, further comprising:
in a single cycle of the half-sine wave signal, when a peak value of the half-sine wave signal is smaller than a peak threshold, the PFC circuit operates in DCM; and
wherein the peak threshold is smaller than the mode threshold.

22. The control method of claim 20, wherein in CCM:
turning off a main power switch of the PFC circuit when an inductor current of the PFC circuit increases to a current peak value; and
turning on the main power switch of the PFC circuit when the inductor current of the PFC circuit decreases to a current valley value.

23. The control method of claim 20, wherein in CCM:
turning off a main power switch of the PFC circuit when an on-time period of a main power switch reaches a time period indicated by an on-time period data;
detecting a first time period from when the main power switch is turned on to when a current sense signal increases to an inductor average current value;
regulating an off-time period of the main power switch of the PFC circuit based on the first time period and the on-time period data; and
turning on the main power switch based on the off-time period of the main power switch; and
wherein the current sense signal indicates an inductor current of the PFC circuit.

24. The control method of claim 20, wherein in CCM:
turning off a main power switch of the PFC circuit when an on-time period of a main power switch reaches a time period indicated by an on-time period data;
detecting a second time period from when a current sense signal starts increasing from an inductor average current value to when the main power switch is turned off;
regulating an off-time period of the main power switch of the PFC circuit based on the second time period and the on-time period data; and
turning on the main power switch based on the off-time period of the main power switch;
wherein the current sense signal indicates an inductor current of the PFC circuit.

25. The control method of claim 20, wherein in BCM:
turning off a main power switch of the PFC circuit when an inductor current of the PFC circuit increases to a current peak value; and
turning on the main power switch of the PFC circuit when the inductor current of the PFC circuit decreases to a current valley value; and
wherein the current peak value is twice of an inductor average current value, the current valley value is zero.

26. The control method of claim 25, wherein in BCM, after the inductor current of the PFC circuit decreases to the current valley value, turning on the main power switch at a first valley of a switching voltage or turning on the main power switch when the switching voltage decreases to a zero-crossing threshold; and
wherein the switching voltage is a voltage of a switching terminal of the PFC circuit.

27. The control method of claim 20, wherein in BCM:
turning off a main power switch of the PFC circuit when an inductor current of the PFC circuit increases to a current peak value; and
turning on the main power switch when a switching voltage of the PFC circuit decreases to zero; and
wherein the switching voltage is a voltage of a switching terminal of the PFC circuit.

28. The control method of claim 21, wherein in DCM:
turning off a main power switch of the PFC circuit when an inductor current of the PFC circuit increases to a current peak value; and
turning on the main power switch of the PFC circuit when a number of ringing valleys of the switching voltage reaches a valley number, wherein the number of ringing valleys is counted from a time when a current sense signal of the PFC circuit decreases to zero, and wherein the switching voltage is a voltage of a switching terminal of the PFC circuit.

29. The control method of claim 21, wherein in DCM:
turning off a main power switch of the PFC circuit when an inductor current of the PFC circuit increases to a current peak value; and
turning on the main power switch when a time period indicated by a delay data is reached from a time when the inductor current of the PFC circuit decreases to zero.

30. The control method of claim 29, wherein in DCM, after the time period indicated by the delay data is reached from the time when the inductor current of the PFC circuit decreases to zero, turning on the main power switch at a first valley of a switching voltage or turning on the main power switch when the switching voltage decreases to a zero-crossing threshold, wherein the switching voltage is a voltage of a switching terminal of the PFC circuit.

31. The control method of claim 21, wherein in DCM:
turning off a main power switch of the PFC circuit when an inductor current of the PFC circuit increases to a current peak value; and
turning on the main power switch of the PFC circuit when a time period indicated by a delay data is reached from a time when a switching voltage of the PFC circuit decreases to zero; and
wherein the switching voltage is a voltage of a switching terminal of the PFC circuit.

32. The control method of claim 20, wherein the half-sine wave signal comprises at least one of an input rectified voltage, a current obtained by rectifying an input current, and an inductor average current value, wherein the input rectified voltage is configured to be obtained by rectifying an AC voltage received by the PFC circuit.
